(19) United States
(12) Patent Application Publication
(10) Pub. No.: US 2008/0081197 A1
(43) Pub. Date: Apr. 3, 2008

(54) Control panel

(76) Inventor: Cathy Huang, Tainan County (TW)

Correspondence Address: BIRCH STEWART KOLASCH & BIRCH, PO BOX 747, FALLS CHURCH, VA, 22040-0747, US

(21) Appl. No.: 11/540,663

(22) Filed: Oct. 2, 2006

(51) Int. Cl. B32B 17/06

(52) U.S. Cl. 428/426

(57) ABSTRACT

A control panel includes a face panel and a bonding membrane. The face panel is a light penetrative plate to be attached to an outer side of a product. The bonding membrane is a thin film sheet and has a front surface or a rear surface printable in a multi-layer fashion. The bonding membrane can be attached to the front surface or the rear surface of the face panel. Through light penetrative characteristics and multi-layer printing of the face panel and bonding membrane, the multi-layer printing graphics on the front surface or the rear surface of the bonding membrane can be projected to the surface of the face panel. Under light projection and different viewing angles, diversified and planar 2D or stereoscopic 3D visual effect can be generated. Hence the added value, aesthetic appeal and practicality of the product can be enhanced.

### FIELD OF THE INVENTION

The present invention relates to a control panel and particularly to a face panel made from a light penetrative plate to be attached by a bonding membrane which has a front surface or a rear surface printable with multi-layer graphics that is bonded to a product to generate diversified and planar 2D or stereoscopic 3D visual effect under light projection and different viewing angles thereby to enhance the added value, aesthetic appeal and practicality of the product.

### BACKGROUND OF THE INVENTION

Refer to FIGS. 1 and 2 for a conventional oven 10. It has a control device 11 which includes a face panel 111, a plurality of rotary knobs 1121, 1131 and 1141, a plurality of pushbuttons 115, 116 and 117, and a switch 118 to open or close a door panel 12.

The face panel 111 has first openings 1120, 1130 and 1140 corresponding to the rotary knobs 1121, 1131 and 1141. The perimeter rim 1110 of the first openings 1120, 1130 and 1140 has graduation marks 1112. The face panel 111 further has second openings 1150, 1160 and 1170 corresponding to the pushbuttons 115, 116 and 117, and an aperture 1180 corresponding to the switch 118.

The control device 11 has a coupling surface 110 which has shafts 112, 113 and 114 mounted thereon to be coupled with the rotary knobs 1121, 1131 and 1141 to control setting of the oven 10.

The first openings 1120, 1130 and 1140 are coupled respectively with the shafts 112, 113 and 114. The second openings 1150, 1160 and 1170 are coupled respectively with the pushbuttons 115, 116 and 117. The aperture 1180 is coupled with the switch 118 of the control panel 12. The face panel 111 is attached tightly to an outer side of the coupling surface 110 of the control device 11 of the oven 10. The face panel 111 further has a bonding surface 1111 attached to the coupling surface 110 to enable the rotary knobs 1121, 1131 and 1141 to be coupled with the shafts 112, 113 and 114. Thereby the rotary knobs 1121, 1131 and 1141 can drive the shafts 112, 113 and 114 to perform setting of the oven 10 when in use.

The face panel 111 is mostly made from opaque materials such as acrylic sheet. Fabrication is limited to printing on the surface. Such a structure has many disadvantages, notably:
1. The graduation marks 1112 printed on the surface of the face panel 111 are easily damaged or eroded due to external factors such as used for a long period of time, scraping, improper cleaning and the like. The indicating function could be affected.
2. For high end products, the face panel 111 spoils the aesthetic appeal of the entire product. The conventional face panel 111 looks tawdry and lowers the image and value of the product.

### SUMMARY OF THE INVENTION

The present invention aims to provide a control panel which has a light penetrative face panel attached by a bonding membrane that has a front surface or a rear surface printed in a multi-layer fashion. The face panel is bonded to a product to generate diversified and planar 2D or stereoscopic 3D visual effect under light projection and different viewing angles. Thus it can enhance the added value, aesthetic appeal and practicality of the product.

To achieve the foregoing object, the control panel according to the invention includes a face panel and a bonding membrane. The face panel is a light penetrative plate to be bonded to an outer side of a product. The bonding membrane is a thin film which has a front surface or a rear surface that can be printed in multi-layer fashion. The bonding membrane can be attached to the front surface or rear surface of the face panel. As the multi-layer printing bonding membrane is attached to the face panel, and the face panel is light penetrative, the printed graphics on the membrane surface can generate a diversified and planar 2D or stereoscopic 3D visual effect under light projection and different viewing angles. As a result, the added value, aesthetic appeal and practicality of the product can be enhanced.

In short, the control panel of the invention can provide the following benefits:
1. Enhance product added value: The face panel is a light penetrative plate with the surface attached to a thin film bonding membrane. The front or rear surface of the bonding membrane can be printed in multi-layer fashion. The bonding membrane is attached to the front or rear surface of the face panel. The multi-layer printing on the bonding membrane and the light penetrative characteristics of the face panel can generate diversified and planar 2D or stereoscopic 3D visual effect under light projection and different viewing angles. The product is more noticeable and the added value of the product increases.
2. Greater aesthetic appeal: As the face panel is a light penetrative plate and has one surface attached to a bonding membrane with multi-layer printing formed thereon, under light projection and different viewing angles, the graphics on the bonding membrane can be projected to the surface of the face panel to generate diversified and planar 2D or stereoscopic 3D visual effect. The bonding membrane can be attached to a product to generate more assembly options and improve aesthetic appeal.
3. Greater practicality: The face panel, with the light penetrative characteristics, has the front surface or rear surface attached to the bonding membrane which has multi-layer printing on the front surface or rear surface thereof. The face panel attached with the bonding membrane can be boned to a product. The printing on the surface of the bonding membrane can resist scraping or erosion without fading even used for a long period of time. Indicating function can be maintained intact. Thus practicality can be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of a conventional technique.

FIG. 2 is an exploded view of a conventional technique.

FIG. 3 is a perspective view of the present invention.

FIG. 4 is an exploded view of the present invention.

FIG. 5 is an exploded view of the bonding membrane of the present invention.

FIG. 6 is an exploded view of another embodiment of the face panel of the present invention.

FIG. 7 is an exploded view of an embodiment of the present invention in a use condition.

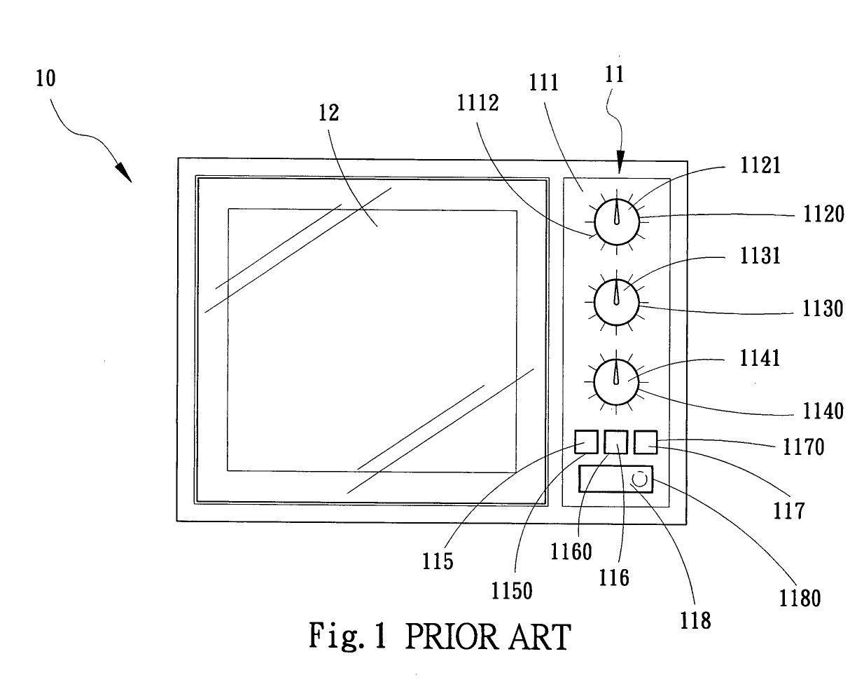

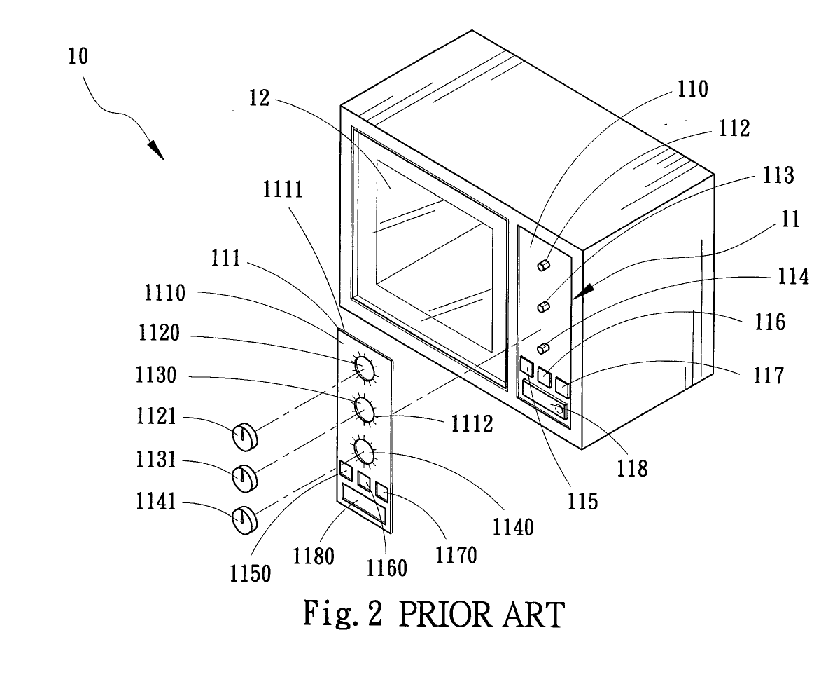

### DETAILED DESCRIPTION OF THE PREFERRED EMBODIMENTS

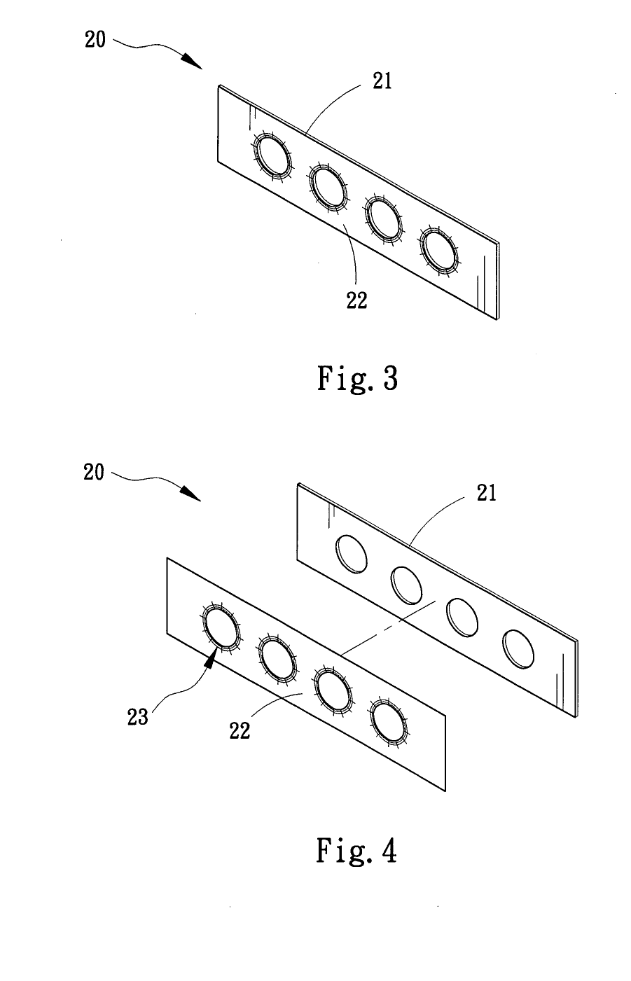

Please refer to FIGS. 3 and 4, the control panel 20 of the invention includes a face panel 21 and a bonding membrane 22.

The face panel 21 is a light penetrative plate made from glass in a desired base color such as brown or transparent. It may be formed in different geometric shapes such as rectangular, square or the like.

The bonding membrane 22 is a thin film sheet formed in a shape mating the face panel 21. It may be transparent or has a base color. It has a front surface and a rear surface. Either the front surface or the rear surface may be printed in a multi-layer fashion. After the printed bonding membrane is attached to the face panel 21 on the front surface (or rear surface) thereof, a diversified appearance is shown.

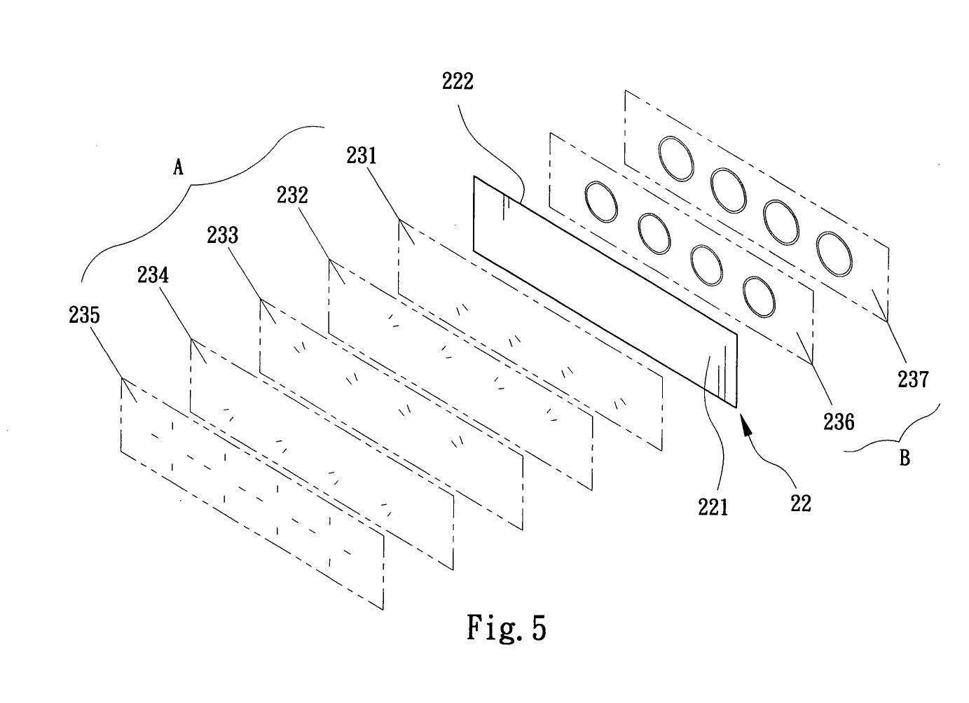

Refer to FIGS. 4 and 5 for an embodiment of the bonding membrane 22 formed in a rectangular shape. It is a thin film sheet with a front surface 221 and a rear surface 222. Either of the front surface 221 or the rear surface 222 may be printed in a multi-layer fashion. The multi-layer printing includes a first layer 231 formed with graphics in red, a second layer 232 printed on the first layer 231 with graphics in orange, in this order, a third layer 233 with graphics in yellow, a fourth layer 234 with graphics in green and a fifth layer 235 with graphics in black. The graphic layers in red, orange, yellow, green and black are jointly form a multi-layer graphics A to be printed on the front surface 221.

Referring to FIG. 5, The rear surface 222 of the bonding membrane 22 also can be printed with graphics in gray on a first layer 236 and a second layer 237 printed on the first layer in blue to form another multi-layer graphics B. Because of the graphics A and B on the front surface 221 or rear surface 222, a resulting printing layer 23 is formed with multi-layer graphics (referring to FIG. 4).

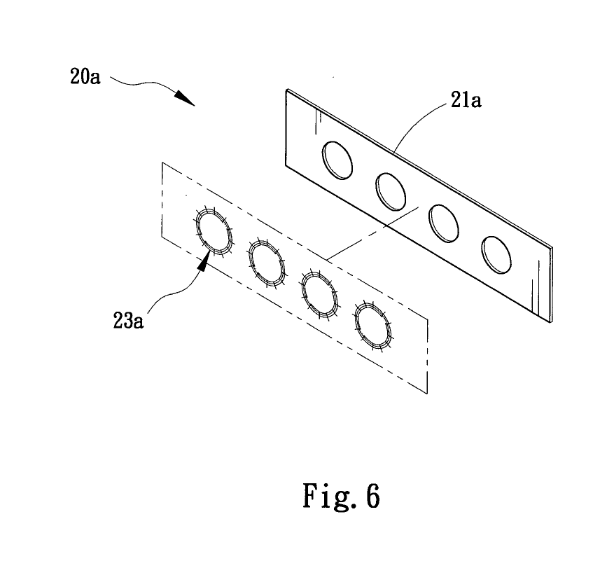

As the face panel 21 is light penetrative, when the bonding membrane 22 is attached to the front surface (or rear surface) of the face panel 21, the multi-layer printing graphics A and B are stacked. Light projection on the face panel 21 can generate planar 2D or stereoscopic 3D visual effect on the surface thereof. Or as shown in FIG. 6, the control panel 20a includes a face panel 21a and a printing layer 23a. The face panel 21a is a light penetrative plate and has a front surface or a rear surface to serve as the printing layer 23a which contains multi-layer colored printing (same as previously discussed, details are omitted). When the face panel 21a is attached to a product, under light projection and different viewing angles, the multi-layer colored printing layer 23a can be projected to the surface of the face panel 21a to generate planar 2D or stereoscopic 3D visual effect. Hence the added value and aesthetic effect of the product can be enhanced.

In addition, because of light penetrative characteristics and thickness of the face panel 21, seeing the face panel 21 under different light projection and viewing angles, the graphics A and B on the bonding membrane 22 can be stacked. Through light refraction on the face panel 21, a diversified effect can be generated on the surface of the face panel 21.

The multi-layer printing previously discussed may also be formed on a single surface of the bonding membrane 22. When the bonding membrane 22 is attached to the face panel 21, the printing graphics on the surface of the bonding membrane 22 can be projected to the face panel 21 to generate another type of planar 2D planar graphics. Printing of the bonding membrane 22 is quite flexible, and can be done according to different requirements to make the bonding membrane 22 more versatile in appearance. Hence when the bonding membrane 22 is attached to the face panel 21, and the face panel 21 is attached to a product, the product also has different looks.

The face panel 21 can be adopted for use on general home appliances such as dish drier, gas range, or the like.

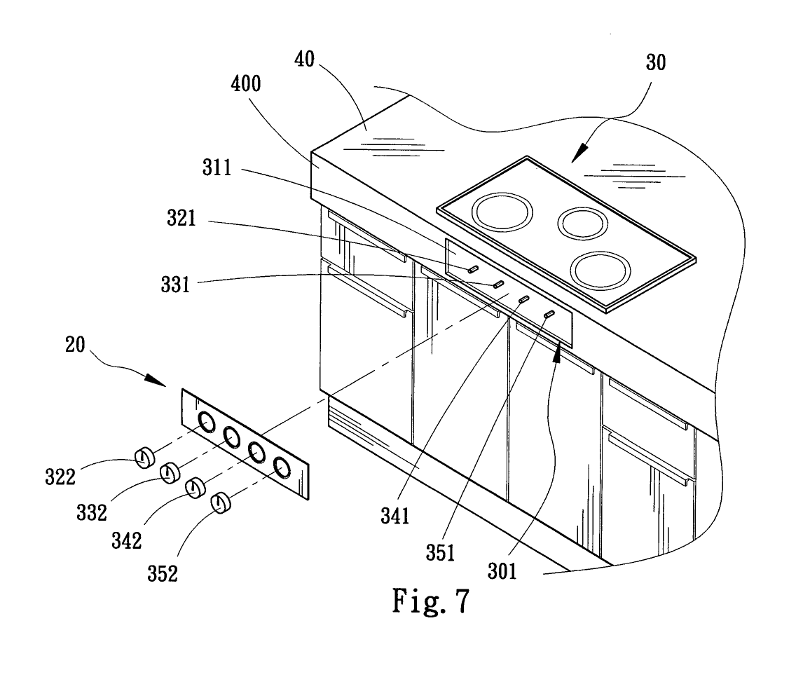

FIG. 7 illustrates an embodiment of the invention used on a gas range 30. It has a control device 301 which includes a control panel 20, a coupling trough 311 to hold the control panel 20, a plurality of rotary shafts 321, 331, 341 and 351 on the coupling trough 311, and a plurality of rotary knobs 322, 332, 342 and 352 coupling on the rotary shafts 321, 331, 341 and 351.

The gas range 30 is installed on a cook top 40. The control device 301 is located on a lateral side 400. The control panel 20 passes through the rotary shafts 321, 331, 341 and 351 to be bonded to the coupling trough 311. Then the rotary knobs 322, 332, 342 and 352 are coupled on the rotary shafts 321, 331, 341 and 351.

Referring to FIG. 7 and previous drawings, the control panel 20 is a light penetrative plate with a front surface (or a rear surface) attached to a bonding membrane 22. The bonding membrane 22 has a front surface 221 and a rear surface 222. Either of the front surface 221 or the rear surface 222 may be printed with colored graphics in a multi-layer fashion. The printing graphics on the front surface 221 includes a first layer 231 in red, a second layer 232 in orange, a third layer 233 in yellow, a fourth layer 234 in green and a fifth layer 235 in black to become a graphics A of different colors. The graphic printing on the rear surface 222 includes a first layer 236 in gray and a second layer in blue to become another graphics B. The graphics A and B thus formed on the bonding membrane 22 can generate multi-layer color.

As previous discussed, through light refraction on the bonding membrane 22, the graphics A and B on the bonding membrane 22 generate a stacking effect. When the bonding membrane 22 is attached to the face panel 21 which in turn is attached to the gas range 30, under different viewing angles and light projection, the graphics A and B on the bonding membrane 22 can generate different stacking effects. As a result, the gas range 30 has a greater aesthetic appeal, and its added value can be enhanced.

What is claimed is:

1. A control panel comprising at least:
a face panel which is a light penetrative plate; and
a bonding membrane which is thin film sheet attached to one surface of the face panel and has a front surface or a rear surface that is printable.

2. The control panel of claim 1, wherein the face panel has a front surface printable in a multi-layer fashion.

3. The control panel of claim 1, wherein the face panel has a rear surface printable in a multi-layer fashion.

4. The control panel of claim 1, wherein the face panel has a base color.

5. The control panel of claim 1, wherein the face panel is transparent.

6. The control panel of claim 5, wherein the face panel is made from glass.

7. The control panel of claim 1, wherein the face panel is formed in a desired geometric shape.

8. The control panel of claim 1, wherein the bonding membrane has a base color.

9. The control panel of claim 1, wherein the bonding membrane is transparent.

10. The control panel of claim 1, wherein the bonding membrane is formed in a shape mating the face panel.
